(19) United States
(12) Patent Application Publication
(10) Pub. No.: US 2018/0297558 A1
(43) Pub. Date: Oct. 18, 2018

(54) Motor Vehicle Access And/Or Start System

(71) Applicant: Continental Automotive GmbH, Hannover (DE)

(72) Inventor: Herbert Froitzheim, Pettendorf (DE)

(73) Assignee: Continental Automotive GmbH, Hannover (DE)

(21) Appl. No.: 15/950,672

(22) Filed: Apr. 11, 2018

(30) Foreign Application Priority Data
Apr. 13, 2017 (DE) 10 2017 206 381.5

(51) Int. Cl. B60R 25/24; E05B 81/00; E05B 83/36; E05F 15/77; B60R 25/01; B60R 25/20

(52) U.S. Cl. CPC B60R 25/24; B60R 2325/205; E05B 83/36; E05F 15/77; B60R 25/01; B60R 25/209; B60Y 2200/11; E05Y 2400/45; E05Y 2400/85; E05Y 2400/664; E05Y 2900/531; B60R 2325/101; B60R 2325/103; B60R 2325/106; E05B 81/00

(57) ABSTRACT

The present disclosure relates to motor vehicles. Various embodiments may include methods and apparatuses for unlocking a motor vehicle using a motor vehicle access and/or start system. For example, a vehicle key for opening, starting, and locking a motor vehicle may include: a first transceiver communicating with the motor vehicle access and start system; a second transceiver communicating with a mobile radio terminal; and a controller which, on the basis of a code received from the mobile radio terminal and in the form of either a release code or a locking code, either releases or locks communication between the vehicle key and the motor vehicle access and start system. The communication is associated with unlocking, starting, and/or locking the motor vehicle.

### CROSS-REFERENCE TO RELATED APPLICATIONS

This application claims priority to DE Application No. 10 2017 206 381.5 filed Apr. 13, 2017, the contents of which are hereby incorporated by reference in their entirety.

### TECHNICAL FIELD

The present disclosure relates to motor vehicles. Various embodiments may include methods and apparatuses for unlocking a motor vehicle using a motor vehicle access and/or start system.

### BACKGROUND

Motor vehicle access and/or start systems are described in PCT/US2015/053341, PCT/EP2017/051698, PCT/EP2017/051529, the disclosures of which are incorporated in the disclosure of this application by reference.

### SUMMARY

Teachings of the present disclosure may be employed to optimize a motor vehicle access and/or start system (for example PASE etc.) for a motor vehicle. For example, a vehicle key (KEYC) for a motor vehicle access and/or start system (VEHIZUG) for opening (OP) and/or starting (ST) and/or locking (LCK) a motor vehicle (VEHI) may include: a transceiver (TKEYCAR) for communicating (COM1; ‘OP’, ‘ST’, ‘LCK’) with the motor vehicle access and/or start system (VEHIZUG), a transceiver (TKEYMS) for communicating (COM2) with a mobile radio terminal (MS), and a controller (CTRLKEYC). The controller may, on the basis of a code (‘FREIC’; ‘VERRC’) which is received (COM2) from a mobile radio terminal (MS) and is in the form of either a (COM2) release code (‘FREIC’) or a locking code (‘VERRC’), to either (‘FREIC’) release (AKT) or (‘VERRC’) to lock (DEAK) communication (COM1) between the vehicle key (KEYC) and the motor vehicle access and/or start system (VEHIZUG), which communication is provided for the purpose of opening (OP, DOR1) and/or starting (STRT; MOTO) and/or locking (LCK, DOR1) the motor vehicle (VEHI).

In some embodiments, the vehicle key (KEYC), in response to a release code (‘FREIC’) or a locking code (‘VERRC’) received (COM2) from the mobile radio terminal (MS), transmits (COM1) a command code (LCK; OP; MOT) relating to opening (OP) or starting (ST) or locking (LCK) of the motor vehicle (VEHI) to the motor vehicle (VEHI) and then locks (DEAK) the vehicle key (KEYC).

In some embodiments, an internal electronic lock is provided in the vehicle key (KEYC), in the controller (CTRLKEYC) of the vehicle key (KEYC), in order, on the basis of a release code (‘FREIC’) or a locking code (‘VERRC’) received from the mobile radio terminal (MS), to either release (AKT) or lock (DEAKT) communication (COM1) between the vehicle key (KEYC) and the motor vehicle access and/or start system (VEHIZUG), which communication is provided for the purpose of opening and/or starting the motor vehicle, in the vehicle key (KEYC), with the result that, in the released state (AKT) of the vehicle key (KEYC), the latter can communicate with the motor vehicle access and/or start system (VEHIZUG) for the purpose of opening (OP) and/or locking (LCK) the motor vehicle (VEHI), whereas, in the locked state (DEAKT) of the vehicle key (KEYC), the latter cannot communicate with the motor vehicle access and/or start system (VEHIZUG) for the purpose of opening (OP) and/or locking (LCK) the motor vehicle (VEHI).

In some embodiments, there is a controller (CTRLKEYC) which is designed on the basis of a code (‘FREIC’; ‘VERRC’) which is received (COM2) from the mobile radio terminal (MS) and is in the form of either a (COM2) release code (‘FREIC’) or a locking code (‘VERRC’), to release (AKT) or deactivate (DEAKT) one or more or all of the following and/or further functions in the vehicle key: communication (COM1) provided for opening (OP, DOR1) and/or communication (COM1) provided for opening (OP, DOR1) only the trunk and/or communication (COM1) provided for starting (STRT; MOTO) and/or communication (COM1) provided for locking (LCK, DOR1).

In some embodiments, the transceiver (TKEYCAR) provided for the purpose of communicating (COM1; ‘OP’, ‘ST’, ‘LCK’) with the motor vehicle access and/or start system (VEHIZUG) and/or the controller (CTRLKEY) of the vehicle key (KEYC) is/are designed to use at least one frequency and/or at least one protocol of the motor vehicle access and/or start system (VEHIZUG).

In some embodiments, the transceiver (TKEYMS) of the vehicle key (KEYC) which is provided for the purpose of communicating (COM2) with the mobile radio terminal (MS) is designed to communicate with the mobile radio terminal (MS) via a wireless interface and/or by short-range radio and/or NFC and/or by Bluetooth and/or WLAN.

In some embodiments, there is a controller (CTRLKEYC) which is designed after receiving (COM2) a locking code (‘VERRC’) from the mobile radio terminal (MS), to release (AKT) or deactivate (DEAKT) only a limited number of executions for one or more or all of the following and/or further functions in the vehicle key: communication (COM1) provided for opening (OP, DOR1) and/or communication (COM1) provided for starting (STRT; MOTO) and/or communication (COM1) provided for locking (LCK, DOR1); with automatic deactivation (DEAKT) and/or definitive destruction of the vehicle key (KEYC) and/or restriction to communication (COM1) provided for locking (LCK, DOR1) after this number of executions.

In some embodiments, there is a controller (CTRLKEYC) which is designed after receiving (COM2) a release code (‘FREIC’) from the mobile radio terminal (MS), to release (AKT) one or more or all of the following and/or further functions in the vehicle key only after a predefined time and/or only for a limited period and/or until a predefined time: communication (COM1) provided for opening (OP, DOR1) and/or communication (COM1) provided for starting (STRT; MOTO) and/or communication (COM1) provided for locking (LCK, DOR1); with automatic deactivation (DEAKT) and/or definitive destruction of the vehicle key (KEYC) and/or restriction to communication (COM1) provided for locking (LCK, DOR1) after this number of executions.

In some embodiments, there is a controller (CTRLKEYC) which is designed to simultaneously allow and/or store a plurality of release codes (‘FREIC’) and/or locking codes (‘VERRC’), and/or to allow release codes (‘FREIC’) and/or locking codes (‘VERRC’) from a plurality of users (BEN).

In some embodiments, a controller (CTRLKEYC) which is designed, after receiving (COM2) a command code (LCK) relating to locking (LCK, DOR1) of the motor vehicle (VEHI) and/or after receiving a locking code (‘VERRC’), to request a notification (MIT), with a time specification and/or a statement relating to the locked state and/or fuel tank level and/or driven kilometers, from the motor vehicle (VEHI) and/or to transmit (COM1) it to the mobile radio terminal (MS).

In some embodiments, there is a controller (CTRLKEYC) which is designed to automatically carry out communication (COM1) with the motor vehicle (VEHI), in particular using one or more RKE messages, which communication is provided for opening (OP, DOR1), after a release code (‘FREIC’) received (COM2) from the mobile radio terminal (MS).

In some embodiments, a controller (CTRLKEYC) which is designed to automatically close (LCK) the motor vehicle (VEHI) and/or to deactivate (DEAKT) the vehicle key (KEYC) if a mobile radio terminal (MS) known to the vehicle key (KEYC) or a further communication terminal (BTCLCK) leaves the communication range of the vehicle key (KEYC), and/or to automatically open the motor vehicle (VEHI), and/or to activate (AKT) the vehicle key (KEYC) if a mobile radio terminal (MS) known to the vehicle key (KEYC) or a further communication terminal (CLCK), in particular a watch, reaches the communication range of the vehicle key (KEYC).

As another example, a mobile radio terminal (MS) may include a controller (CTRLMS) and a transceiver (TMSMOB) which are designed to communicate with a cellular mobile radio network (TELE), having a controller (CTRLMS) and a transceiver (TMSKEY), which are designed to communicate with a vehicle key (KEYC) for a motor vehicle access and/or start system (VEHIZUG), wherein the mobile radio terminal (MS) is designed to transmit a release code (‘FREIC’) to the vehicle key (KEYC), wherein the mobile radio terminal (MS) is designed to transmit a locking code (‘VERRC’) to the vehicle key (KEYC), and wherein the mobile radio terminal (MS) preferably also has an input interface (INP) for receiving a selection by the user (BEN) with regard to either a release code (‘FREIC’) to be transmitted or a locking code (‘VERRC’) to be transmitted.

In some embodiments, the mobile radio terminal (MS) is designed, after transmission of a command code (LCK) relating to locking (LCK, DOR1) of the motor vehicle (VEHI) to the vehicle key (KEYC), as confirmed in particular by the vehicle key (KEYC), and/or after transmission (COM2) of a release code (‘FREIC’) and/or a locking code (‘VERRC’) to the vehicle key (KEYC), as confirmed in particular by the vehicle key (KEYC), to transmit (COMTELE) a notification (MIT), in particular with a time specification, via a mobile radio network (TELE), in particular to a service provider or a motor vehicle rental company.

In some embodiments, the mobile radio terminal (MS) is designed to implement release codes (‘FREIC’) and/or locking codes (‘VERRC’) received from a server (SERV) in the vehicle key (KEYC) by communicating (COM2) with the vehicle key (KEYC), in particular for the purpose of teaching the vehicle key (KEYC) to the mobile radio terminal (MS) and/or with a check of the identity of the mobile radio terminal (MS) and/or its SIM card and/or a password with respect to the server.

In some embodiments, there is a motor vehicle access and/or start system (VEHIZUG) which (VEHIZUG; CTRLVEHI; DOR1; MOTO) is designed to cause (DOR1; MOTO) a motor vehicle (VEHI) to be opened (OP) or started (ST) or closed (LCK) on the basis of communication (COM1) with the vehicle key (KEYC).

As another example, some embodiments may include a method, in particular using a vehicle key (KEYC) for a motor vehicle access and/or start system (VEHIZUG) and/or a mobile radio terminal (MS) as claimed in one of the preceding claims, wherein the vehicle key (KEYC) receives a code (‘FREIC’; ‘VERRC’) in the form of either a (COM2) release code (‘FREIC’) or a locking code (‘VERRC’) from a mobile radio terminal (MS), and wherein the vehicle key (KEYC) communicates (COM1; ‘OP’, ‘ST’, ‘LCK’) with the motor vehicle access and/or start system (VEHIZUG), in particular for the purpose of opening (OP) and/or starting (ST) and/or closing (LCK) a motor vehicle (VEHI), only after receiving a release code (‘FREIC’) and before receiving a locking code (‘VERRC’) and/or before a time.

### BRIEF DESCRIPTION OF THE DRAWINGS

Further features and advantages of some configurations will emerge from the following description of exemplary embodiments of the invention with reference to the drawing, in which, to illustrate some possible configurations of the invention, FIG. schematically shows, by way of example, in a simplifying manner, an overview of communication between a mobile radio terminal, a motor vehicle key and a motor vehicle controller of an engine start and/or vehicle access system for a motor vehicle.

### DETAILED DESCRIPTION

Various embodiments of the teachings herein may make it possible to efficiently implement at least one releasable and lockable vehicle key and/or a mobile radio terminal and/or a system and/or a method for an engine start and/or vehicle access system (for a motor vehicle and/or a motor vehicle fleet). For example, some embodiments may include an apparatus in (at least) one vehicle key (for example in the form of a radio key or a card etc.) for an engine start and/or vehicle access system for a motor vehicle and/or in a mobile radio terminal, in particular in the form of a mobile radio terminal suitable, in particular, for communicating with a cellular mobile radio network (such as 2G, 3G, 4G, 5G, TDMA, CDMA, TDCDMA, WCDMA, OFDM etc.), and/or in a system (having a vehicle key and a mobile radio terminal).

In some embodiments, (at least) one vehicle key may exist for a motor vehicle, which vehicle key is taught to the motor vehicle in a conventional manner, for example, and has at least one function for opening and/or closing and/or starting etc. a motor vehicle by radio (in particular RKE) but also has an internal electronic lock (for releasing and locking the vehicle key, in particular by radio, by means of a mobile radio terminal, with the result that the vehicle key can open/close/start/etc. a motor vehicle, for example between release by radio and (passage of time or number of operations or) locking by radio).

In some embodiments, such an internal electronic lock (for example function for releasing and locking the vehicle key, in particular by radio, by means of a mobile radio terminal) can be operated via a wireless interface (for example Bluetooth or NFC or ZigBee or WiFi or WLAN or other short-range radio, for example with a range of below 50 m or 10 m or 1 m or 0.1 m) and can be locked or opened using codes and/or protocols provided for this purpose and renders the vehicle key, when locked, electronically unusable, for example, or grants it only selected operations (for example open trunk etc.).

In some embodiments, at least (for example RKE-based) opening and (for example RKE-based) closing of a motor vehicle can be available by means of the wireless interface when the lock is unlocked.

In some embodiments, the vehicle secrets (for example codes and/or protocols which can be used for (encrypted) communication between the vehicle key and the motor vehicle for the purpose of opening/closing/starting) always remain locked in the vehicle key and cannot be read.

In some embodiments, such an arrangement makes it possible to lock (that is to say deactivate) a conventionally learned and usable vehicle key and to also leave it behind, in a locked form, in a vehicle locked by it: the vehicle key, for example, is placed into the motor vehicle, the instruction to close the motor vehicle via the vehicle key (by means of RKE, for example) is given by command from mobile communication electronics, for example from a mobile radio terminal (for example a smartphone, a tablet or a smartphone-compatible watch BTCLCK) and the command to lock the vehicle key is then given, with the result that the vehicle key remains unusable even after breaking into the motor vehicle.

In some embodiments, the apparatus allows the closing and locking process to be logged by the vehicle key and to furthermore block access to the vehicle key without newly generated codes. If this is transmitted to the mobile radio terminal (for example smartphone) by means of a signed message and the information is ultimately transmitted to a vehicle rental company, logged vehicle return to precisely this vehicle rental company is enabled. In some embodiments, the time (for example including the date) in the vehicle key is also concomitantly transferred with the message to the mobile radio terminal.

In some embodiments, it is possible to predefine, as theft protection, the number of operations and/or a time limit, after which the electronic lock (implemented, for example, as a program in a controller of the vehicle key) renders the vehicle key unusable or allows only vehicle return, for example.

In some embodiments, the vehicle key can be released (activated) with a code only after a certain duration or in a predefined period or the vehicle key itself can be used only at predefined times, which can make the possible uses more flexible, for example for vehicle rental or fleet solution.

In some embodiments, codes (release codes for releasing the vehicle key and/or locking codes for locking the vehicle key) are managed in communication electronics (for example as a program in a controller of a mobile radio terminal) belonging to the owner. In this case, a secret (code and/or protocol), for example, is initially interchanged between the vehicle key and the communication electronics (for example of the mobile radio terminal). With the aid of this secret, it is then possible for the owner/proprietor of the motor vehicle, for example, to create and forward corresponding codes for vehicle users.

In some embodiments, codes (release codes for releasing the vehicle key and/or locking codes for locking the vehicle key) are managed on a server and are transferred (for example to the vehicle key and/or the mobile radio terminal), with the result that the vehicle owner can grant the authorization to use the vehicle via this server.

In some embodiments, the electronic lock and/or the key can alternately allow and/or store and/or use codes from a plurality of owners with respect to the motor vehicle access and/or start system (parallel/overlapping).

In some embodiments, special codes are generated and/or used, which codes only allow, for example, the opening of the trunk, which can be used, for example, by parcel delivery services to collect or deliver parcels after accordingly transferring the code, provided that the vehicle key remains in the motor vehicle.

In some embodiments, other data which are available to the vehicle key are also transmitted, for example, to a motor vehicle rental company (for example via a mobile radio terminal and/or by mobile radio, for example, to a server), for example in the case of motor vehicle return. Said data are, for example, the locked state, the fuel tank level or driven kilometers, for example provided that these data are stored in the vehicle key by the motor vehicle.

In some embodiments, if these data are not stored in the vehicle key, it is possible to fetch these data from an “on-board unit” using a diagnostic function, for example, and/or from the motor vehicle via a wireless interface shortly before or after the motor vehicle has been locked in order to ensure that the retrieved values are up-to-date.

In some embodiments, the identity of the person renting a motor vehicle is checked by means of measures in the communication electronics (for example password, SIM, etc.) before codes which are then used to rent a motor vehicle are sent to said person.

In some embodiments, the motor vehicle is apparently immediately opened by the borrowing and is locked by the return, but by means of one or more (for example RKE) messages from the vehicle key each time.

In some embodiments, the vehicle key is handed over, for example as usual, by a person at a counter, and the electronic lock and/or the vehicle key is/are used only to limit the rental time of the motor vehicle or for unsupervised return.

In some embodiments, the vehicle key is allowed to automatically lock the motor vehicle if a known device leaves the communication range (of the vehicle key) and to open it again if the device approaches the communication range in order to lock the vehicle key in the motor vehicle and to lock it if absent, for example by means of an NFC or WLAN or Bluetooth (diving) watch.

In some embodiments, the electronic lock or the release in the vehicle key is or remains activated only as long as another communication device (for example mobile radio terminal/smartphone) is in the range of the vehicle key. The key secret otherwise remains sealed for a finder/thief of the vehicle key.

In some embodiments, equipping the vehicle key with an electronic lock (locking or releasing the vehicle key) results in the possibility of generating and transferring electronic vehicle keys. As a result, the vehicle key can otherwise remain unchanged and there is no need for any changes to the motor vehicle. Only in the event of a motor vehicle being transferred (or for access by parcel services or the like), the vehicle key can remain in the vehicle, for example, or can be at least in radio range or is directly handed over at the counter. This makes it possible to avoid changing the motor vehicle and to avoid circumventing the security mechanisms of the motor vehicle. After being transferred, the motor vehicle behaves as in the original case with all convenience functions of the vehicle access and start (for example access via radio, passive entry and go etc.).

In some embodiments, it is also possible to issue electronic keys (codes) with a restricted range of functions (for example only opening and closing or time-limited functions).

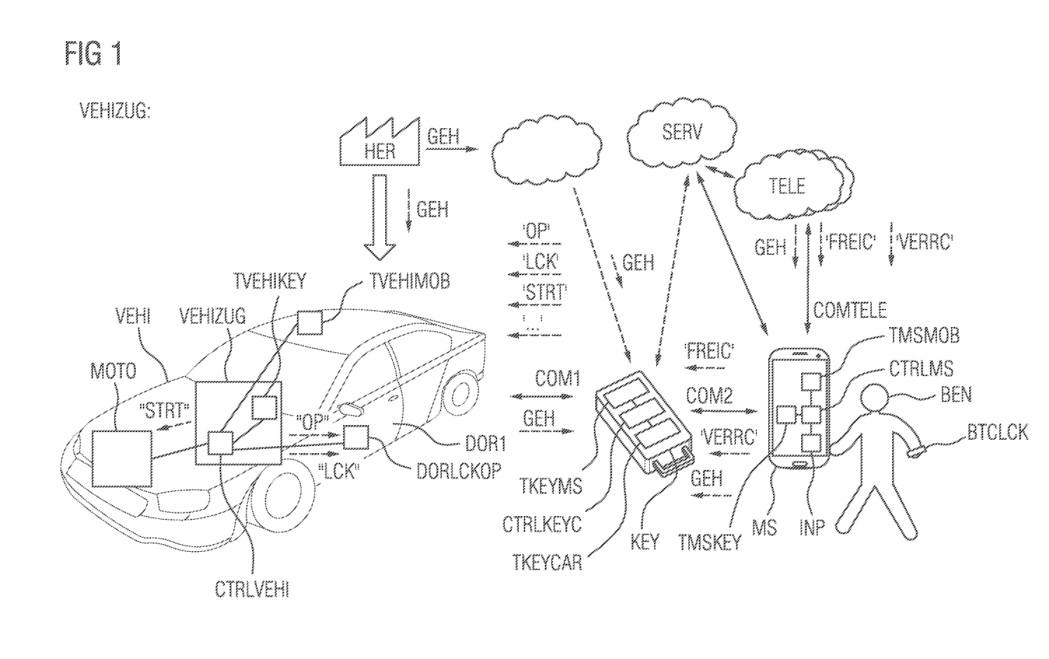

FIG. 1 shows an overview of some components (for example each interacting by radio) VEHIZUG, KEYC, MS (and, if appropriate, TELE, SERV, HER) for a motor vehicle access and/or start system VEHIZUG for a motor vehicle VEHI (in particular an automobile or a truck or a motorcycle or a bus or a commercial vehicle). FIG. 1 also shows communication COM2 between a mobile radio terminal MS and a vehicle key KEYC and communication COM1 between a vehicle key KEYC and a motor vehicle access and/or start system VEHIZUG in a motor vehicle VEHI, as well as communication COMTELE between a mobile radio terminal MS and a cellular mobile radio network TELE and communication between a mobile radio network TELE and a server SERV and/or a server at a workshop or a manufacturer HER.

In some embodiments, the vehicle key KEYC only opens/closes (locks)/starts/etc. the motor vehicle VEHI (by radio etc.) when it has been activated (released, AKT) for this purpose by a mobile radio terminal MS using a release code FREIC but has not yet been deactivated (DEAKT; or a time has expired etc.) (and preferably only if it is also requested to open or close the vehicle or start the engine, for example by approaching the motor vehicle or by a user pressing a button and/or in another manner).

The motor vehicle access and/or start system. VEHIZUG in the motor vehicle VEHI communicates (COM1, for example via one or more transponders) with the vehicle key KEYC and receives, from the vehicle key KEYC, instructions, for example, to open OP (via a vehicle bus and a door opener DORLCKOP, for example) a door Dor1 or to start STRT a drive MOTO or to lock LCK (a door opener DORLCKOP of) a door DOR1 of the motor vehicle (VEHICOM1). The engine start and/or vehicle access system VEHIZUG for a motor vehicle VEHI could also receive secrets GEH and/or protocols GEH for encrypted communication with a vehicle key via a mobile radio network antenna TVEHIMOB and a mobile radio network etc. or in a wired manner etc. from a further server belonging to a workshop or a manufacturer HER.

Secrets GEH such as codes and/or protocols (for encrypted communication between the vehicle key KEYC and the engine start and/or vehicle access system VEHIZUG and/or the mobile radio terminal MS) could be introduced into the vehicle key KEYC and/or (in the same manner or in a suitable manner) into the motor vehicle VEHI and/or the mobile radio terminal MS, for example by a server SERV, via a mobile radio network TELE using a mobile radio terminal MS (and could possibly be transferred to the radio key by radio and could possibly be transferred from there to the vehicle access system VEHIZUG) and/or could have been introduced into the vehicle key KEYC and/or into the motor vehicle VEHI, for example by the manufacturer HER or a workshop etc., for example by radio.

In some embodiments, the vehicle key KEYC for the motor vehicle access and/or start system VEHIZUG causes (for example by radio; COM1) the motor vehicle access and/or start system VEHIZUG to open OP a (trunk/driver's/passenger) door DOR1 and/or to start ST an engine MOTO and/or to lock LCK (a (trunk/driver's/passenger) door DOR1 of) the motor vehicle VEHI, for example, only when it has been released (‘FREIC’, AKT) by a mobile radio terminal MS (designed for cellular mobile radio, for example) and/or is not locked (‘VERRC’, DEAKT; time).

The vehicle key KEYC may include, for example:
a transceiver TKEYCAR for communicating (COM1; ‘OP’, ‘STRT’, ‘LCK’, etc. (′ . . . ′)) with the motor vehicle access and/or start system VEHIZUG, in particular for the purpose of opening (OP) or starting (ST) or locking (LCK) the motor vehicle VEHI,
a transceiver TKEYMS for (radio) communication (COM2) with a mobile radio terminal MS (for example for releasing to a state AKT or for locking to a state DEAKT of the vehicle key KEYC by means of the mobile radio terminal MS by radio), and
a controller CTRLKEYC which, on the basis of a code (FREIC; VERRC) received from the mobile radio terminal MS (for example by radio, for example Bluetooth/NFC/WiFi/WLAN/other short-range radio etc.; COM2) and is in the form of either a release code (FREIC) or a locking code (VERRC), to either (in the case of a release code FREIC) release (AKT) or (in the case of a locking code VERRC) to lock (DEAK) (for example radio) communication COM1 between the vehicle key KEYC and the motor vehicle access and/or start system VEHIZUG, which communication is provided for the purpose of opening (OP, DOR1) and/or starting (STRT; MOTO) or locking (LCK, DOR1) the motor vehicle VEHI.

The mobile radio terminal MS may include, for example:
a controller CTRLMS and a transceiver TMSMOB designed to communicate with a cellular mobile radio network TELE (for example with regard to frequencies and/or protocols), and
a controller CTRLMS and a transceiver TMSKEY designed to communicate (COM2) with a vehicle key KEYC (TKEYMS) for a motor vehicle access and/or start system VEHIZUG (for example with regard to frequencies and/or protocols),
wherein the mobile radio terminal MS is designed to transmit a release code FREIC to the vehicle key KEYC (for example after input by a user BEN) in order to activate AKT it, with the result that it can be used, for example, to open ‘OP’ and/or close ‘LCK’ or start ‘STRT’ a motor vehicle VEHI by radio, for example at the touch of a button or upon approach etc.,
wherein the mobile radio terminal MS is designed to transmit a locking code VERRC to the vehicle key KEYC in order to deactivate DEAKT it, with the result that it can now no longer be used, for example, to open and/or close or start a motor vehicle by radio, for example at the touch of a button or upon approach etc.,
wherein the mobile radio terminal MS has an input interface INP (for example a keyboard, voice input, screen input etc.) for receiving a selection by a user BEN with regard to either a release code FREIC to be transmitted or a locking code VERRC to be transmitted.

Single or double quotation marks of the reference symbols can indicate (possibly different) encryption, for example.

1. A vehicle key for opening, starting, and locking a motor vehicle, the vehicle key comprising:
a first transceiver communicating with the motor vehicle access and start system;
a second transceiver communicating with a mobile radio terminal; and
a controller which, on the basis of a code received from the mobile radio terminal and in the form of either a release code or a locking code, either releases or locks communication between the vehicle key and the motor vehicle access and start system;
wherein the communication is associated with opening, starting, and/or locking the motor vehicle.

2. The vehicle key as claimed in claim 1, wherein the controller, in response to a release code or a locking code received from the mobile radio terminal at the second transceiver, transmits a command code relating to opening or starting or locking the motor vehicle to the motor vehicle through the first transceiver.

3. The vehicle key as claimed in claim 1, further comprising an internal electronic lock in the controller;
wherein, on the basis of a release code or a locking code received from the mobile radio terminal, the internal electric lock either releases or locks communication between the vehicle key and the motor vehicle access and start system;
wherein, in the released state, the vehicle key can communicate with the motor vehicle access and start system for the purpose of opening and/or locking the motor vehicle; and
in the locked state, the vehicle key cannot communicate with the motor vehicle access and start system for the purpose of opening or locking the motor vehicle.

4. The vehicle key as claimed in claim 1, further comprising a controller which, on the basis of a code received from the mobile radio terminal in the form of either a release code or a locking code, releases or deactivates one or more of the following functions in the vehicle key: communication for opening the locks, communication for opening the trunk, communication for starting an engine, and communication locking the locks.

5. The vehicle key as claimed in claim 1, wherein at least one of the transceiver and the controller uses a frequency or a protocol of the motor vehicle access and start system.

6. The vehicle key as claimed in claim 1, wherein the second transceiver communicates with the mobile radio terminal via at least one of a wireless interface, by short-range radio, NFC, by Bluetooth, and WLAN.

7. The vehicle key as claimed in claim 1, wherein the controller, after receiving a locking code from the mobile radio terminal, releases, or deactivates only a limited number of executions for at least one of the following functions in the vehicle key: communication for opening, communication for starting, and communication for locking;
with automatic deactivation of the vehicle key and/or restriction to communication provided for locking after the limited number of executions is reached.

8. The vehicle key as claimed in claim 1, wherein the controller, after receiving a release code from the mobile radio terminal, releases at least one of the following functions in the vehicle key only after a predefined time, only for a limited period, or until a predefined time:
communication for opening, communication for starting, and communication for locking;
with automatic deactivation after the limited number of executions is reached.

9. The vehicle key as claimed in claim 1, wherein the controller allows and stores a plurality of release codes and/or locking codes.

10. The vehicle key as claimed in claim 1, wherein the controller, after receiving a command code relating to locking the motor vehicle, requests a notification with at least one of: a time specification, a statement relating to the locked state, a fuel tank level, and driven kilometers, from the motor vehicle.

11. The vehicle key as claimed in claim 1, wherein the controller automatically carries out communication with the motor vehicle using one or more RKE messages for opening the locks after a release code is received from the mobile radio terminal.

12. The vehicle key as claimed in claim 1, wherein the controller automatically locks the motor vehicle or deactivates the vehicle key if a mobile radio terminal known to the vehicle key leaves the communication range of the vehicle key (KEYC).

13. A mobile radio terminal comprising:
a first controller and a first transceiver communicating with a cellular mobile radio network; and
a second controller and a second transceiver communicating with a vehicle key for a motor vehicle access and start system;
wherein the mobile radio terminal operates to transmit a release code to the vehicle key;
wherein the mobile radio terminal operates to transmit a locking code to the vehicle key; and
the mobile radio terminal includes an input interface for receiving a selection by the user with regard to either a release code or a locking code to be transmitted.

14. The mobile radio terminal as claimed in claim 13, wherein the mobile radio terminal, after transmitting a command code relating to locking the motor vehicle to the vehicle key, as confirmed by the vehicle key, or after transmission of a release code or a locking code to the vehicle key, transmits a notification with a time specification, via a mobile radio network, to a service provider or a motor vehicle rental company.

15. The mobile radio terminal as claimed in claim 13, wherein the mobile radio terminal implements release codes and/or locking codes received from a server by communicating with the vehicle key for the purpose of introducing the vehicle key to the mobile radio terminal.

16. A system comprising:
a vehicle key for a motor vehicle access and start system, the vehicle key comprising:
a first transceiver communicating with the motor vehicle access and start system;
a second transceiver communicating with a mobile radio terminal; and
a controller which, on the basis of a code received from the mobile radio terminal and in the form of either a release code or a locking code, either releases or locks communication between the vehicle key and the motor vehicle access and start system;
wherein the communication is associated with opening, starting, and/or locking the motor vehicle;
a mobile radio terminal comprising:
a first controller and a first transceiver communicating with a cellular mobile radio network; and
a second controller and a second transceiver communicating with a vehicle key for a motor vehicle access and start system;
wherein the mobile radio terminal operates to transmit a release code to the vehicle key;
wherein the mobile radio terminal operates to transmit a locking code to the vehicle key; and
the mobile radio terminal includes an input interface for receiving a selection by the user with regard to either a release code or a locking code to be transmitted; and
a motor vehicle access and start system which causes a motor vehicle to be unlocked or started or locked on the basis of communication with the vehicle key.

17. A method using a vehicle key for a motor vehicle access and start system, the method comprising:
receiving a code at the vehicle key in the form of either a release code or a locking code from a mobile radio terminal;
communicating from the vehicle key to the motor vehicle access and start system to unlock, start, or lock the motor vehicle (VEHI), only upon receiving a release code; and
not communicating to the motor vehicle if the vehicle key receives a locking code.

18. The vehicle key as claimed in claim 1, wherein the controller automatically opens the motor vehicle and/or activates the vehicle key if a mobile radio terminal known to the vehicle key reaches the communication range of the vehicle key.
